(19) United States
(12) Patent Application Publication
(10) Pub. No.: US 2009/0189464 A1
(43) Pub. Date: Jul. 30, 2009

(54) Solenoid Actuator

(75) Inventor: Adam Schilffarth, Cedar Park, TX (US)

Correspondence Address: DAFFER MCDANIEL LLP, P.O. BOX 684908, AUSTIN, TX, 78768, US

(73) Assignee: LUMINEX CORPORATION, Austin, TX (US)

(21) Appl. No.: 12/359,837

(22) Filed: Jan. 26, 2009

Related U.S. Application Data
(60) Provisional application No. 61/023,671, filed on Jan. 25, 2008.
(60) Provisional application No. 61/045,721, filed on Apr. 17, 2008.

(51) Int. Cl. H02K 41/00

(52) U.S. Cl. 310/12.04

(57) ABSTRACT

A fluid assay system and a method for immobilizing magnetic particles within a fluid assay system are provided which employ a vessel for receiving magnetic particles and a solenoid actuator comprising a core component and a coil of wire wound around at least a portion of the core component. The solenoid actuator is configured such that an application of current through the coil of wire moves the core component toward the vessel. In some cases, core component includes a magnet to immobilize one or more magnetic particles disposed within the vessel. An embodiment of the solenoid actuator includes a telescoping body holding a core component and a coil of wire wound around at least a portion of the telescoping body.

### PRIORITY APPLICATION

The present application claims priority to U.S. Provisional Application No. 61/023,671 filed Jan. 25, 2008 and U.S. Provisional Application No. 61/045,721 filed Apr. 17, 2008.

### BACKGROUND OF THE INVENTION

1. Field of the Invention

This invention generally relates to solenoid actuators.

2. Description of the Related Art

The following descriptions and examples are not admitted to be prior art by virtue of their inclusion within this section.

Fluid assays are used for a variety of purposes, including but not limited to biological screenings and environmental assessments. Often, particles are used in fluid assays to aid in the detection of analytes of interest within a sample. In particular, particles provide a substrate for carrying reagents configured to react with analytes of interest within a sample such that the analytes may be detected. In many cases, magnetic materials are incorporated into particles such that the particles may be immobilized by magnetic fields during the preparation and/or analysis of a fluid assay. In particular, particles may, in some embodiments, be immobilized during an assay preparation process such that excess reagents and/or reactionary byproducts superfluous to the impending assay may be removed therefrom. In addition or alternatively, particles may, in some cases, be immobilized during analysis of a fluid assay such that data relating to analytes of interest in the assay may be collected (e.g., imaged) from a fixed object.

In any case, immobilization may generally be performed for only a fraction of the time used to prepare and/or analyze an assay such that the particles may be allowed to be suspended in and/or flow with the assay. In addition, the immobilization may be performed once or multiple times during the preparation and/or analysis of a fluid assay depending on the specifications of the process. For such reasons, it is generally necessary to intermittently introduce and retract a magnetic actuator in the vicinity of a vessel comprising the magnetic particles. In some cases, however, the inclusion of a magnetic actuation device within a fluid assay system may complicate the design of the system, particularly hindering the ability to introduce assay/sample/reagent plates and/or vessels into the system.

As such, it would be advantageous to develop a compact device configured to intermittently introduce and retract a magnetic actuator in the vicinity of a vessel of a fluid assay system, which is further configured to be non-intrusive to other components of the system.

### SUMMARY OF THE INVENTION

The following description of various embodiments of a fluid assay system, a solenoid actuator, and method for immobilizing magnetic particles within a fluid assay system is not to be construed in any way as limiting the subject matter of the appended claims.

An embodiment of a fluid assay system includes a vessel and a solenoid actuator comprising a telescoping body holding a core component and a coil of wire wound around at least a portion of the telescoping body. The solenoid actuator is configured such that upon application of current through the coil of wire the core component moves toward the vessel.

Another embodiment of a fluid assay system includes a vessel and a solenoid actuator comprising a core with a permanent magnet and a coil of wire wound around at least a portion of the core. The solenoid actuator is configured such that when the core is retracted relative to the vessel, the solenoid actuator comprises a thickness of less than approximately 15 mm from a base level of the coil of wire to an opposing end of the core and the solenoid actuator is spaced apart from the vessel by at least approximately 10 mm. In addition, the solenoid actuator is configured such that when the core is fully extended toward the vessel, the permanent magnet is in close enough proximity to the vessel to immobilize one or more magnetic particles arranged therein.

An embodiment of a solenoid actuator includes a telescoping body holding a core component and a coil of wire wound around at least a portion of the telescoping body.

An embodiment of a method for immobilizing magnetic particles within a fluid assay system includes introducing a plurality of magnetic particles into a vessel of the fluid assay system and applying a first current through a coil of wire of a solenoid actuator spaced adjacent to the vessel. The application of first current is such that an electromagnetic field is produced which is sufficient to repel a permanent magnet comprising a core of the solenoid from the coil of wire and in sufficient proximity to the vessel such that the permanent magnet immobilizes the plurality of magnetic particles.

### BRIEF DESCRIPTION OF THE DRAWINGS

Other objects and advantages of the invention will become apparent upon reading the following detailed description and upon reference to the accompanying drawings in which:

FIG. 1A illustrates a partial cross-sectional view of a fluid assay system in which a magnetic actuating core of a solenoid actuator is retracted;

FIG. 1B illustrates a partial cross-sectional view of the fluid assay system depicted in FIG. 1A when the magnetic actuating core is extended;

FIG. 2A illustrates a perspective view of the solenoid actuator depicted in FIG. 1A when the magnetic actuating core is retracted;

FIG. 2B illustrates a perspective view of the solenoid actuator depicted in FIG. 2A when the magnetic actuating core is extended;

FIG. 3 illustrates a partial cross-sectional view of the fluid assay system depicted in FIG. 1B having a different configuration of a magnet arranged within the magnetic actuating core;

FIG. 4 illustrates a partial cross-sectional view of the fluid assay system depicted in FIG. 1B having yet another different configuration of a magnet arranged within the magnetic actuating core;

FIG. 5 illustrates a partial cross-sectional view of the a fluid assay system having a different configuration of a solenoid actuator relative to the fluid assay system depicted in FIG. 1B; and

FIG. 6 illustrates a flow chart of an exemplary method for immobilizing magnetic particles within a fluid assay system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

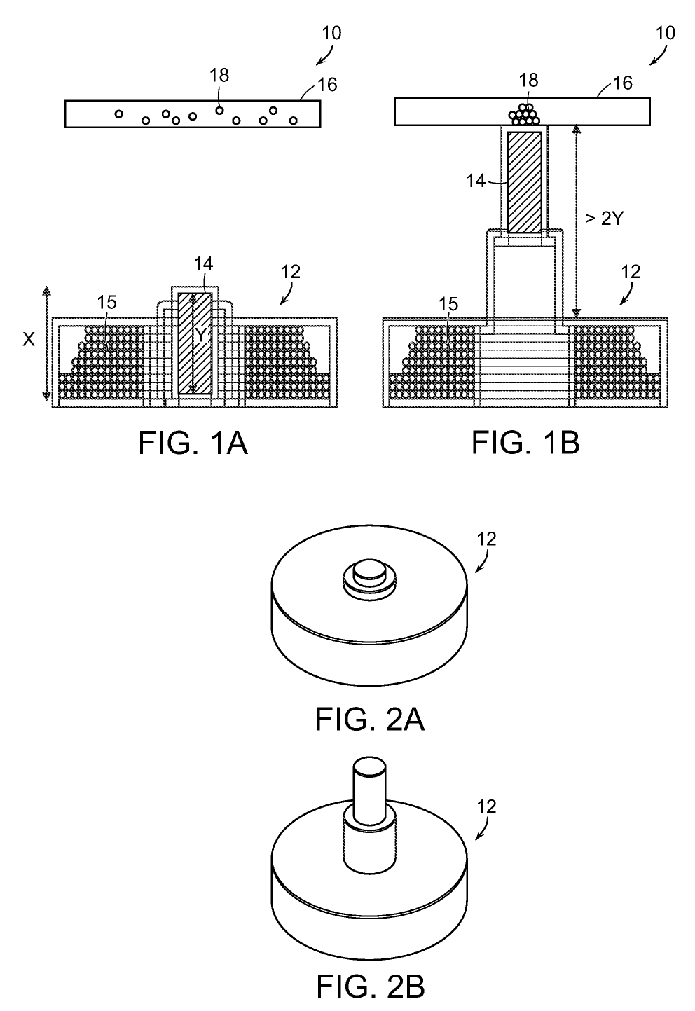

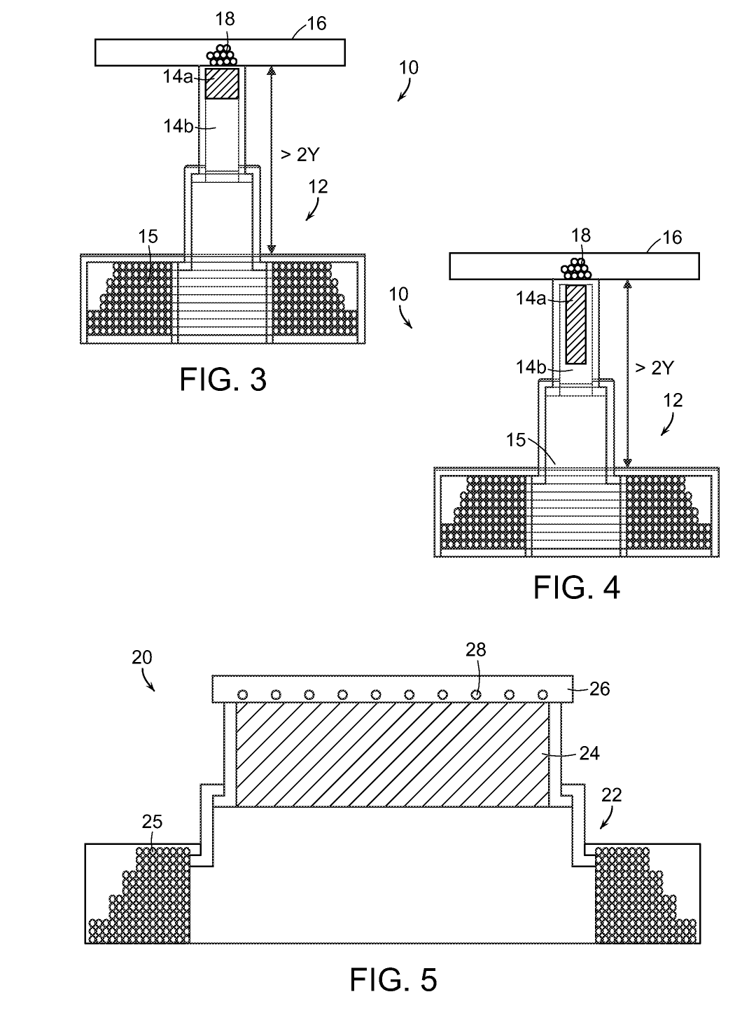

Turning to the drawings, exemplary embodiments of solenoid actuators, fluid assay systems including such solenoid actuators, and methods employing such systems are shown. In particular, FIGS. 1A and 1B illustrate partial cross-sectional views of fluid assay system 10 in which magnetic actuating core 14 of solenoid actuator 12 is retracted and extended relative to vessel 16, respectively. In addition, FIGS. 2A and 2B illustrate exemplary perspective views of solenoid actuator 12 when magnetic actuating core 14 is retracted and extended, respectively. FIGS. 3-5 illustrate alternative embodiments of fluid assay system 10 particularly with respect to different configurations of magnetic actuating core 14. FIG. 6 illustrates a flow chart of an exemplary method for immobilizing magnetic particles within a fluid assay system using the solenoid actuators described herein. It is noted that the figures are not necessarily drawn to scale. In particular, the scale of some elements in some of the figures may be greatly exaggerated to emphasize characteristics of the elements. In addition, it is further noted that the figures are not drawn to the same scale. The term “solenoid actuator” used herein may generally refer to a device including a coil of wire wound around a metallic core. The term “magnetic” refers to either being magnetized or the capability of being magnetized or attracted by a magnet. The term “magnet” refers to an object that is surrounded by a magnetic field, either naturally or induced, and that has a property of attracting or repelling another magnetic material. The term “permanent magnet” refers to a magnet that retains its magnetism after removal of the magnetizing force.

Fluid assay system 10 may generally include a system configured to process (i.e., prepare and/or analyze) a fluid assay. The fluid assay may include any biological, chemical, or environmental fluid in which determination of the presence or absence of one or more analytes of interest is desired. In order to facilitate the methods described herein, the fluid assay is processed to include magnetic particles and, as such, a vessel of the fluid assay system may be configured to receive a plurality of magnetic particles. As shown in FIGS. 1A and 1B, vessel 16 of fluid assay system 10 includes magnetic particles 18. Magnetic particles 18 may generally be included within a fluid in vessel 16 and, therefore, may be suspended within vessel 16 when magnetic actuating core 14 is retracted as shown in FIG. 1A. Conversely, magnetic particles 18 may be clustered and immobilized at the bottom of vessel 16 when magnetic actuating core 14 is extended in proximity to vessel 16 as shown in FIG. 1B. The term “particle” is used herein to generally refer to microspheres, polystyrene beads, quantum dots, nanodots, nanoparticles, nanoshells, beads, microbeads, latex particles, latex beads, fluorescent beads, fluorescent particles, colored particles, colored beads, tissue, cells, micro-organisms, organic matter, non-organic matter, or any other discrete substrates or substances known in the art. Any of such terms may be used interchangeably herein. Exemplary magnetic microspheres which may be used for the methods and systems described herein include xMAP® microspheres, which may be obtained commercially from Luminex Corporation of Austin, Tex.

As shown in FIG. 1A and 1B, solenoid actuator 12 includes coil of wire 15 comprising a base of the solenoid actuator and wound at a spaced distance around magnetic actuating core 14 when the core is retracted. Coil of wire 15 serves as a pathway for current such that a magnetic field may be generated in alignment with a vector field of a permanent magnet arranged in magnetic actuating core 14. The generated magnetic field in turn provides a force by which to move (i.e., extend or retract) magnetic actuating core 14. More specifically, when current is applied to coil of wire 15 such that a resulting magnetic field vector is aligned in an opposite direction (i.e., anti-parallel) to the magnetic field vector of the permanent magnet arranged in magnetic actuating core 14 then the core moves toward vessel 16 and specifically in sufficient vicinity of vessel 16 to immobilize magnetic particles 18. Conversely, when current is applied to coil of wire 15 such that a resulting magnetic field vector is aligned in the same direction (i.e., parallel) as the magnetic field vector of the permanent magnet arranged in magnetic actuating core 14 then the core moves away from vessel 16 (or stays in the retracted position). As shown in FIGS. 1A and 1B, coil of wire 15 may be wound so that the density of wire is larger at the bottom (i.e., the region of solenoid actuator 12 farthest from vessel 16) than the top (i.e., the region of solenoid actuator 12 closest to vessel 16). Alternatively stated, coil of wire 15 may be wound to have a decreasing density of wire relative to the direction of outward movement of magnetic actuating core 14. This causes the force vector generated by current through coil of wire 15 to be upward when extending magnetic actuating core 14 toward vessel 16. Without this asymmetry, there is no reliable direction to the force vector.

Given the configuration and use of solenoid actuator 12 as described above, magnetic actuating core 14 serves a dual purpose within fluid assay system 10. In particular, magnetic actuating core 14 provides a force vector by which to operate solenoid actuator 12 and further functions to immobilize magnetic particles 18 for processing a fluid assay. This is believed to be a notable difference from conventional solenoid actuators employing magnetic bars. In particular, magnetic bars in conventional solenoid actuators may provide a force vector to aid in operating the solenoid actuator, but the function of their extension from the solenoid base is generally mechanical in nature. In particular, conventional solenoid actuators employing magnetic bars generally utilize the extension of the magnetic bars to act as mechanical switches.

As noted above, the inclusion of a conventional magnetic actuation device within a fluid assay system may, in some embodiments, hinder the ability to introduce assay/sample/reagent plates and/or vessels into a system, specifically due to their bulky nature and need to be in proximity to the process vessel containing the magnetic particles. The solenoid actuators described herein, however, may be designed to circumvent such an issue. In particular, the solenoid actuators described herein may be configured to retract at least a majority portion of magnetic actuating core 14 within coil of wire 15 when particle immobilization is not needed. Although the solenoid actuators described herein are not necessarily so limited, one manner for facilitating such retraction includes a telescoping body holding magnetic actuating core 14 as shown in FIGS. 1A-5. With such a design configuration, a magnetic field generated from an application of current through coil of wire 15 may move magnetic actuating core 14 inward and outward with the telescoping body. In this manner, a relatively large clearance may be maintained between solenoid actuator 12 and vessel 16 when magnetic actuating core 14 is retracted such that assay/sample/reagent plates may be brought in or out of the system without being obstructed. As noted below, an exemplary distance for such a clearance when magnetic actuating core 14 is retracted may be between approximately 10 mm and approximately 20 mm but, larger or smaller distances may be considered.

In some embodiments, the telescoping body of solenoid actuator 12 may be configured to extend magnetic actuating core 14 a distance greater than twice a length of magnetic actuating core 14, as denoted by dimensions Y and 2Y in FIGS. 1A and 1B, respectively. Alternatively stated, solenoid actuator 12 may be positioned relative to vessel 16 such that when magnetic actuating core 14 is retracted within coil of wire 15, magnetic actuating core 14 is spaced apart from vessel 16 by at least a distance twice of its length. In any case, the telescoping body may be configured to nest its cylindrical sections such that they protrude slightly from the adjoining outer surface of solenoid actuator 12 as shown in FIGS. 1A and 2A. In other embodiments, however, the telescoping body may be configured to nest its cylindrical sections such that they are coplanar or recessed slightly relative to the adjoining outer surface of solenoid actuator 12. In any case, as described below, the height (or width) of solenoid actuator 12 when magnetic actuating core 14 is retracted may, in some cases, be less than or equal to approximately 15 mm and, thus, the length of the telescoping body when condensed may be less than or equal to approximately 15 mm in some cases.

In general, magnetic actuating core 14 and coil of wire 15 may be configured such that when magnetic actuating core 14 is extended toward vessel 16, magnetic particles 18 are immobilized. Such configurations may vary widely for different applications and different design specifications of fluid assay systems and, thus, should not be restricted to generalizations discussed herein. Exemplary specifications for coil of wire 15 includes 30 AWG gauge wire having a relatively thin insulating layer such that the wire may be wound to fit in a small space. Other and different wire characterizations may be considered as well. For example, the efficacy of solenoid actuator 12 may generally increase as the number of windings of wire around magnetic actuating core 14 increases and, thus, the number of windings making up coil of wire 15 may vary with particular design specifications.

As noted above, magnetic actuating core 14 includes a permanent magnet. The configuration of the permanent magnet may vary among applications as discussed in more detail with respect to FIGS. 1A, 1B, 3, and 4. In particular, in some cases, the permanent magnet may make up the entirety of magnetic actuating core 14 as shown in FIGS. 1A and 1B. In other embodiments, however, the permanent magnet may comprise less than the entirety of magnetic actuating core 14, such as shown in FIGS. 3 and 4. In such illustrations, the permanent magnet is denoted by reference number 14a and the remaining portions of magnetic actuating core 14 made up of non-magnetic material is denoted by reference number 14b. In some embodiments, it may be advantageous to position the permanent magnet at the distal end of magnetic actuating core 14 as shown in FIG. 3. In particular, such a configuration may help facilitate the immobilization of magnetic particles 18 within vessel 16 when magnetic actuating core is extended toward vessel 16. In other embodiments, however, the permanent magnet may be arranged apart from the distal end of magnetic actuating core 14.

In any case, the permanent magnet may, in some embodiments, comprise a majority of the magnetic actuating core, such as shown in FIG. 4, or may comprise less than a majority of the core, such as shown in FIG. 3. Furthermore, the permanent magnet may span the entire width of magnetic actuating core 14 as shown in FIG. 3 or may span less than the entire with of the core, such as shown in FIG. 4. It is noted that the different configurations of permanent magnet 14a noted above and illustrated in FIGS. 3 and 4 are not necessarily mutually exclusive. In particular, any combination of the features noted above may make up a permanent magnet within the solenoid actuators described herein. In general, the dimensional and layout configurations of the permanent magnet within magnetic actuating core 14 may depend on the strength of the magnetic fields generated by the permanent magnet, coil of wire 15, and magnetic particles 18 as well as the distance solenoid actuator 12 is configured to extend magnetic actuating core 14 in order to immobilize the magnetic particles. It is noted that contrary to the depictions of FIGS. 1B and 3-5, magnetic actuating core 14 (or the sleeve encasing the core) need not necessarily come into contact with vessel 16 in order to immobilize magnetic particles 18. Such specificity may generally depend on the strength of the magnetic fields of the magnetic actuating core and the particles. Furthermore, it is noted that the end of magnetic actuating core 14 need not be encased as shown in FIGS. 1B and 3-5. Alternatively stated, the permanent magnet of magnetic actuating core 14 may be exposed at the end of the core in some cases.

The strength (i.e., grade or measure of force of attraction) of a magnetic material is generally based on its maximum energy product (a.k.a., BH_{MAX}), which is the product of the material's residual magnetic flux density (generally measured in Gauss) and the material's coercive magnetic field strength (generally measured in Oersteds). It is generally advantageous for the permanent magnet discussed above with respect to magnetic actuating core 14 to have a higher BH_{MAX} than what coil of wire 15 can generate through the application of current. In particular, such a threshold may insure the direction of the magnetic vector field of the permanent magnet may not be altered by the electromagnetic field generated by coil of wire 15. For the solenoid configurations described herein, a permanent magnet having a BH_{MAX} greater than approximately 10.0 and, in some embodiments, greater than approximately 15.0 may be generally suitable. In some cases, a permanent magnet having a BH_{MAX} of at least approximately 40.0 may be particularly advantageous such that one of a variety of wire coils may be employed without caution to exceeding the magnetic field of the permanent magnet. The grade of a magnet directly refers to its BH_{MAX} and, thus, in such embodiments, the permanent magnet considered for magnetic actuating core 14 may have at least a grade 40 (N40) magnet.

Rare earth materials (a.k.a., lanthanide materials or inner transition element materials) generally offer a range of maximum energy product greater than 10.0 and, thus, may be particularly suitable for the permanent magnet arranged within magnetic actuating core 14. The term “rare earth material”, as used herein, refers to a material including any of the 15 rare earth elements from lanthanium to lutetium in the periodic table. Exemplary materials include sintered or bonded neodymium-iron-boron (NdFeB), sintered or bonded samarium cobalt (SmCo), and any nitrides or carbides thereof. Other rare earth materials also exist as magnetic materials and may be used for the permanent magnet arranged within magnetic actuating core 14.

The size and space occupied by magnetic actuating core 14 and coil of wire 15, respectively, may contribute to their configuration to immobilize magnetic particles 18 and, thus, may vary widely among applications as well. Exemplary dimensions for magnetic actuating core 14 used for the development of the solenoid actuators described in reference to FIGS. 1A-4 include a diameter of approximately 0.25 inches and a height of approximately 0.5 inches (denoted as dimension Y). Exemplary dimensions for coil of wire 15 used for the development of the solenoid actuators described in reference to FIGS. 1A-4 include an inner diameter of approximately 17 mm, an outer diameter of approximately 35 mm, and a height of approximately 14.7 mm. Larger or smaller dimensions, however, may be considered for magnetic actuating core 14 and coil of wire 15. For example, it was discovered during the development of the solenoid actuators described herein that magnetic fields generated by coil of wire 15 may generally be made faster and stronger as the inner diameter of coil of wire 15 decreases relative to a fixed width dimension of magnetic actuating core 14. As such, it may be advantageous for coil of wire 15 to have an inner diameter less than three times a width dimension of magnetic actuating core 14 in some cases.

In any case, the height (or width) of solenoid actuator 12 when magnetic actuating core 14 is retracted (denoted as dimension X in FIG. 1A) may vary among different applications and systems as well. In other words, the amount magnetic actuating core 14 is retracted within coil of wire 15 or the amount of magnetic actuating core 14 protrudes from coil of wire when no current is applied may vary among different applications and systems. In some cases, it may be advantageous to minimize such a dimension to minimize the size of solenoid actuator 12 and, thus, the space it occupies within a system. For example, dimension X denoted in FIG. 1 may, in some cases, be less than or equal to approximately 15 mm. As shown in FIGS. 1A and 2A, such minimization of the width of solenoid actuator 12 may be accomplished by configuring the solenoid actuator to retract nearly the full length of magnetic actuating core 14. In other cases, solenoid actuator 12 may be configured to retract the full length of magnetic actuating core 14 or alternatively may be configured to recess magnetic actuating core 14 relative to coil of wire 15. In any of such cases, the distance between the base of coil of wire 15 and the opposing distal end of magnetic actuating core 14 may be relatively short. As a result, solenoid actuator 12 may relatively compact as compared to conventional solenoid actuators. In other embodiments, however, solenoid actuator 12 may not be configured to retract magnet actuating core 14 to such a degree relative to coil of wire 15 and, thus, the configurations of solenoid actuators described herein are not necessarily limited to the depictions in the figures.

In addition to the configurations of magnetic actuating core 14 and coil of wire 15 discussed above, the distance between solenoid actuator 12 and vessel 16 may vary among different applications and systems as well. Exemplary distances between solenoid actuator 12 (specifically coil of wire 15) and vessel 16 used for the development of the fluid assay systems described herein were generally at least approximately 10 mm and, in some cases, at least approximately 20 mm. Such distances were used to insure that magnetic particles 18 were not inadvertently immobilized when magnetic actuating core 14 was not fully extended. In particular, timing of particle immobilization is important to insure proper processing of a biological, chemical, or environmental sample into an assay and/or proper analysis of an assay and, thus, such a distance may allow sufficient clearance from vessel 16 when immobilization is not needed. Furthermore, a spacing of at least approximately 10 mm and, in some cases, at least approximately 20 mm may open up a passage to allow assay/sample/reagent plates and/or vessels to be more easily introduced into fluid assay system 10 relative to fluid assay systems having a bulky magnetic actuator in proximity to vessels arranged therein. Nonetheless, distances shorter than approximately 10 mm between solenoid actuator 12 and vessel 16 may be considered for the systems described herein.

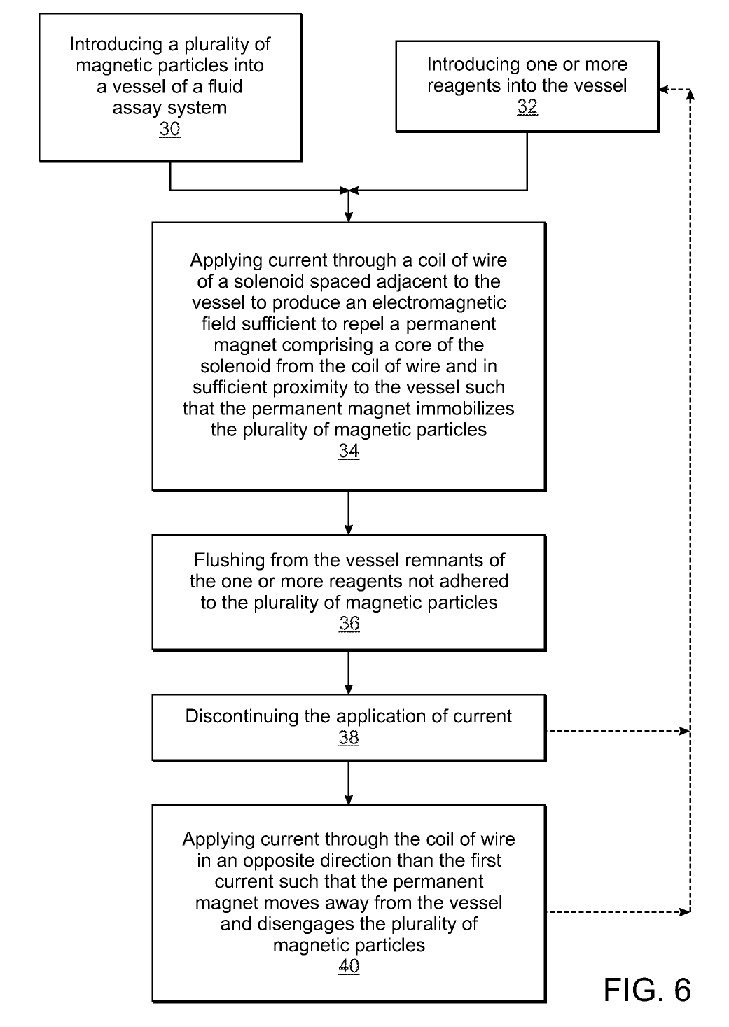

As shown in FIGS. 1A-4, the solenoid actuators described in reference thereto may, in some cases, be used to immobilize a mass of magnetic particles. Such mass immobilization may be particularly suitable for a fluid assay system which is configured to process a biological, chemical, or environment sample into an assay using a plurality of magnetic particles. In some cases, however, it may be advantageous to use solenoid actuators described herein to immobilize magnetic particles individually for analyzing an assay. Fluid assay systems which immobilize particles for examination are generally referred to as static systems. Such systems may still include a fluidic handling system for transporting a fluid assay and possibly other fluids to a particle examination chamber (and, thus, may still be referred to as fluid assay systems), but the examination chamber may be generally configured to immobilize particles of the fluid assay for examination. Exemplary static imaging optical analysis systems having such a configuration are described in the U.S. patent application Ser. No. 11/757,841 entitled “Systems and Methods for Performing Measurements of One or More Materials” by Roth et al. filed on Jun. 4, 2007, which is incorporated by reference as if set forth fully herein. As noted in U.S. patent application Ser. No. 11/757,841, the static systems described therein are configured to immobilize magnetic particles in an array. In view of such a configuration, it may beneficial, in some embodiments, to configure the dimensions of magnetic actuating core 14 and coil of wire 15 to accommodate immobilization of magnetic particles in an array. FIG. 5 illustrates an exemplary embodiment of a fluid assay system in view of such considerations.

In particular, FIG. 5 illustrates fluid assay system 20 including vessel 26 and solenoid actuator 22 having coil of wire 25 and magnetic actuating core 24 extending therefrom to immobilize magnetic particles 28 in an array within vessel 26. Other than their dimensional configurations, the characteristics of solenoid actuator 22, magnetic actuating core 24, and coil of wire 25 may generally include the same as those described above for solenoid actuator 12, magnetic actuating core 14, and coil of wire 15. The characteristics are not reiterated for the sake of brevity, but are referenced as if set forth in their entirety. As shown in FIG. 5, the width dimension of magnetic actuating core 24, and more specifically the permanent magnet arranged therein, may be similar or the same as the width dimension of vessel 26. In this manner, magnetic particles 28 may be immobilized without being massed within vessel 26. In such cases, vessel 26 serves as the examination chamber of fluid assay system 20. In some configurations, vessel 26 may be configured to position magnetic particles 28 in an array and solenoid actuator 22 may be used to secure and release the magnetic particles from such a layout.

It is noted that the fluid assay systems described herein are not restricted to the illustrations of FIGS. 1A, 1B, and 3-5. In particular, fluid assay systems 10 and 20 may include other components, such as but not limited to an assembly of valves, pumps and fluid pathways for introducing fluids into the system as well as expelling them. In addition, it is noted that fluid assay systems 10 and 20 are not restricted to having solenoid actuator 12/22 and vessel 16/26 positioned in the manner depicted in FIGS. 1A, 1B, and 3-5. In particular, solenoid actuator 12/22 and vessel 16/26 may be alternatively positioned such that magnetic actuating core 14/24 moves in a horizontal or near horizontal direction. In yet other embodiments, solenoid actuator 12/22 may be positioned above vessel 16/26 such that magnetic actuating core 14/24 moves in a substantially downward direction when moving in proximity to vessel 16/26. It is noted that positioning solenoid actuator 12/22 relative to vessel 16/26 such that magnetic actuating core 14/24 is allowed to move in a substantially vertical position (i.e., above or below vessel 16/26) may be advantageous in some embodiments. In particular, gravitational forces may aid in moving (i.e., extending or retracting) magnetic actuating core 14/24 in at least one direction relative to vessel 16 in such cases.

As noted above, the solenoid actuators described herein are not necessarily limited to having a telescoping body as illustrated in FIGS. 1A-5. Rather, the solenoid actuators may alternatively be configured to slidingly extend and retract a magnetic actuating bar along a fixed sleeve in proximity to a vessel of a fluid assay. Furthermore, it is noted the telescoping configuration described herein is not necessarily limited to the solenoid actuators described herein. In particular, it is contemplated that other solenoid actuators may benefit from employing a telescoping body to retract and extend a core component, regardless of the configuration core component and/or any other components included in the solenoid actuator. In particular, it is believed a telescoping body may be employed in several different configurations of solenoid actuators used for magnetic actuation, electrical actuation, and/or mechanical actuation.

A flowchart of an exemplary method for immobilizing magnetic particles within a fluid assay system using the solenoid actuators described herein is depicted in FIG. 6. In particular, FIG. 6 illustrates a flow chart including block 40 in which a plurality of magnetic particles are introduced into a vessel of a fluid assay system. The plurality of magnetic particles may be similar to the description of magnetic particles 18 described in reference to FIGS. 1A and 1B. Such a description is not repeated for the sake of brevity. In addition to the introduction of magnetic particles, the method may further include introducing one or more reagents into the vessel as shown in block 32 in FIG. 6. More specifically, the method may include introducing one or more reagents into the vessel prior to, during, or after the magnetic particles have been introduced into the vessel. In some embodiments, the one or more reagents may include reagents used for the preparation of a fluid assay, such as but are not limited to a biological, chemical, or environmental sample, one or more antibodies, one or more chemical tags, and buffers. In other embodiments, the one or more reagents may include a fluid assay previously prepared.

In any case, the method may continue to block 34 in which current is applied through a coil of wire of a solenoid actuator spaced adjacent to the vessel to produce an electromagnetic field sufficient to repel a permanent magnet comprising a core of the solenoid from the coil of wire and in sufficient proximity to the vessel such that the permanent magnet immobilizes the plurality of magnetic particles. The application of current may vary widely among different applications. An exemplary current application used for the development of the solenoid actuators and methods described herein included approximately 1.25 amps, but larger and smaller current applications may be considered. During the application of current referred to in block 34, the method may include flushing from the vessel remnants of the one or more reagents not adhered to the plurality of magnetic particles as shown in block 36. In particular, unreacted reagents may be removed from the system vessel. Subsequent thereto, the application of current may be discontinued as shown in block 38. In some embodiments, such a discontinuation of current may be sufficient such that the core component of the solenoid comprising the permanent magnet moves away from the vessel and disengages the plurality of magnetic particles due to gravitational forces. In other embodiments, however, the method may need an application of current through the coil of wire in an opposite direction such that the core component comprising the permanent magnet moves away from the vessel and disengages the plurality of magnetic particles as shown in block 40.

In either case, the method may, in some embodiments, terminate after disengaging the plurality of magnetic particles. In other cases, however, the method may continue by introducing one or more additional reagents into the vessel as shown by the dotted lines extending from blocks 38 and 40 to block 32 in FIG. 6. It is noted that such a course of action is optional and, thus, is denoted in FIG. 6 by dotted lines. Subsequent thereto, the method may continue to blocks 34-38 or 34-40 to process the magnetic particles relative to the one or more additional reagents. Such a process may be reiterated any number of times. It is noted that the methods described herein are not necessarily restricted to the flowchart depicted in FIG. 6. In particular, the method described herein may include one or more additional steps for preparing and/or processing a fluid assay.

It will be appreciated to those skilled in the art having the benefit of this disclosure that this invention is believed to provide solenoid actuators, fluid assay systems including solenoid actuators, and methods employing such systems. Further modifications and alternative embodiments of various aspects of the invention will be apparent to those skilled in the art in view of this description. For example, as noted above, the telescoping configuration described herein is not necessarily limited to the solenoid configurations described herein. It is believed several different solenoid actuators may benefit from a telescoping design. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A fluid assay system, comprising:
a vessel; and
a solenoid actuator, comprising:
a telescoping body holding a core component; and
a coil of wire wound around at least a portion of the telescoping body, wherein the solenoid actuator is configured such that upon application of current through the coil of wire the core component moves toward the vessel.

2. The fluid assay system of claim 1, wherein the telescoping body is configured to extend the core component a distance from its retracted position greater than twice a length of the core component.

3. The fluid assay system of claim 1, wherein when the core component is retracted relative to the vessel, the solenoid actuator is spaced apart from the vessel by at least approximately 10 mm.

4. The solenoid actuator of claim 1, wherein a length of the telescoping body when condensed is less than approximately 15 mm.

5. The fluid assay system of claim 1, wherein the core component comprises a permanent magnet.

6. The fluid assay system of claim 5, wherein the permanent magnet is a rare earth magnet.

7. The fluid assay system of claim 5, wherein the permanent magnet comprises the opposing end of the core component.

8. The fluid assay system of claim 5, wherein the permanent magnet comprises a majority portion of the core component.

9. A solenoid actuator, comprising:
a telescoping body holding a core component; and
a coil of wire wound around at least a portion of the telescoping body.

10. The solenoid actuator of claim 9, wherein the telescoping body is configured to extend the core component a distance from its retracted position greater than twice a length of the core component.

11. The solenoid actuator of claim 9, wherein the coil of wire is wound such that the coil has a decreasing density of wire in the direction of outward movement of the core component.

12. The solenoid actuator of claim 9, wherein the inner diameter of the coil is less than three times a width dimension of the core component.

13. The solenoid actuator of claim 9, wherein a length of the telescoping body when condensed is less than approximately 15 mm.

14. The solenoid actuator of claim 9, wherein the core comprises a permanent magnet.

15. The solenoid actuator of claim 14, wherein the permanent magnet is a rare earth magnet.

16. The solenoid actuator of claim 14, wherein the permanent magnet comprises at least a grade forty magnet.

17. A method for immobilizing magnetic particles within a fluid assay system, comprising:
introducing a plurality of magnetic particles into a vessel of a fluid assay system; and
applying a first current through a coil of wire of a solenoid spaced adjacent to the vessel to produce an electromagnetic field sufficient to repel a permanent magnet comprising a core of the solenoid from the coil of wire and in sufficient proximity to the vessel such that the permanent magnet immobilizes the plurality of magnetic particles.

18. The method of claim 17, further comprising discontinuing the application of first current, and wherein discontinuing the application of first current causes the permanent magnet to move away from the vessel and disengage the plurality of magnetic particles due to gravitational forces.

19. The method of claim 17, further comprising:
discontinuing the application of first current; and
applying a second current through the coil of wire in an opposite direction than the first current such that the permanent magnet moves away from the vessel and disengages the plurality of magnetic particles.

20. The method of claim 17, further comprising:
introducing one or more reagents into the vessel prior to applying the first current; and
during the step of applying the first current, flushing from the vessel remnants of the one or more reagents not adhered to the plurality of magnetic particles.

21. The method of claim 20, further comprising:
discontinuing the application of first current such that the permanent magnet moves away from the vessel and disengages the plurality of magnetic particles; and
introducing one or more additional reagents into the vessel subsequent to discontinuing the first current.

22. The method of claim 21, further comprising:
applying a second current through the coil such that the permanent magnet moves in sufficient proximity to the vessel to immobilize the plurality of magnetic particles subsequent to introducing the one or more additional reagents into the vessel; and
during the step of applying the second current, flushing from the vessel remnants of the one or more additional reagents not adhered to the plurality of magnetic particles.

23. A fluid assay system, comprising:
a vessel; and
a solenoid actuator, comprising:
a core with a permanent magnet; and
a coil of wire wound around at least a portion of the core, wherein the solenoid actuator is configured such that:
when the core is retracted relative to the vessel, the solenoid actuator comprises a thickness of less than approximately 15 mm from a base level of the coil of wire to an opposing end of the core and the solenoid actuator is spaced apart from the vessel by at least approximately 10 mm; and
when the core is fully extended toward the vessel, the permanent magnet is in close enough proximity to the vessel to immobilize one or more magnetic particles arranged therein.

24. The fluid assay system of claim 23, wherein the system is configured to prepare a fluid assay.

25. The fluid assay system of claim 23, wherein the solenoid actuator further comprises a telescoping body holding the core.

26. The fluid assay system of claim 23, wherein when the core is retracted relative to the vessel, the solenoid actuator is spaced apart from the vessel by at least approximately 20 mm.

27. The fluid assay system of claim 23, wherein the solenoid actuator is disposed below the vessel.
